(19) United States
(12) Patent Application Publication
(10) Pub. No.: US 2023/0142620 A1
(43) Pub. Date: May 11, 2023

(54) Ammonia Synthesis System and Method

(71) Applicant: InfraSalience Ltd., London (GB)

(72) Inventor: Roger Caldwell, Austin, TX (US)

(73) Assignee: InfraSalience Ltd., London (GB)

(21) Appl. No.: 18/048,613

(22) Filed: Oct. 21, 2022

Related U.S. Application Data
(60) Provisional application No. 63/262,841, filed on Oct. 21, 2021.

(51) Int. Cl. C25B 1/27; C25B 15/08; C25B 15/02; C25B 9/70; C25B 9/17; H05H 1/46

(52) U.S. Cl. CPC C25B 1/27; C25B 15/087; C25B 15/02; C25B 9/70; C25B 9/17; H05H 1/466; C25B 15/083

(57) ABSTRACT

The techniques described herein relate to methods for the synthesis of ammonia from nitrogen and hydrogen, the methods including use of plasma, such as a microjet plasma, in a first reaction chamber to generate a vibrationally exited nitrogen atom or nitrogen containing molecule, optionally wherein the excited nitrogen atom or molecule is reacted with hydrogen in an aqueous medium, optionally wherein the medium is then recycled to remove soluble products. A system for carrying out such methods is also provided.

### RELATED APPLICATION(S)

This application claims priority to and the benefit of U.S. Provisional Application No. 63/262,841 Filed Oct. 21, 2021, the contents of which is incorporated herein by reference in its entirety.

### FIELD

The present disclosure relates to improved methods for the generation of ammonia from nitrogen and hydrogen.

### BACKGROUND

In light of the targets set out by the Paris Climate Agreement and the global energy sector's ongoing transition from fossil fuels to renewables, the chemical industry is searching for innovative ways of reducing greenhouse gas emissions associated with the production of ammonia.

The present disclosure improved processes and systems for the production of ammonia.

### SUMMARY

In some aspects, the techniques described herein relate to a method for synthesis of ammonia from nitrogen and hydrogen, the method including use of plasma, such as a microjet plasma, in a first reaction chamber to generate a vibrationally excited nitrogen atom or nitrogen containing molecule, optionally wherein the vibrationally excited nitrogen atom or molecule is reacted with hydrogen in an aqueous medium, optionally wherein the aqueous medium is then recycled to remove soluble products.

In some aspects, the techniques described herein relate to a method wherein said plasma is a microjet plasma generated by RF energy conducted through a gas between two electrodes designated as an RF electrode and a GND electrode.

In some aspects, the techniques described herein relate to a method wherein a spacing between the two electrodes (gap including gas) is between 5 mm and 1 mm, and a gas pressure is between 0.8 Barg and 5 Barg.

In some aspects, the techniques described herein relate to a method where both electrodes include an alloy of at least 90% tungsten by weight.

In some aspects, the techniques described herein relate to a method wherein gas flows through an annulus where an outer surface of the annulus is a GND electrode, and an inner surface of the annulus is an RF electrode, resulting in a cross-sectional gas flow area determined by a radii of both electrodes (R1=GND radius; R2=RF radius), optionally wherein a length of RF electrode is substantially larger than a thickness of the GND electrode (L1=GND electrode thickness), resulting in a discharge volume that is proportional to (R1−R2)*L1, where R1−R2 is an effective electrode spacing.

In some aspects, the techniques described herein relate to a method wherein a gas flow rate achieves a velocity between 0.1-0.90 Mach within a volume of the effective electrode spacing.

In some aspects, the techniques described herein relate to a method wherein a gas from the first reaction chamber flows directly into a second reaction chamber wherein said second reaction chamber is a two celled electrolytic reactor including an anolyte cell having an anode and a catholyte cell having a cathode.

In some aspects, the techniques described herein relate to a method where an excited gas from a first microjet plasma reactor is injected into the anolyte cell in close proximity to the anode.

In some aspects, the techniques described herein relate to a method wherein the anode is substantially coated with an alloy including nickel.

In some aspects, the techniques described herein relate to a method wherein a gas flow rate is sufficient for the gas to reach the anode within 1 second.

In some aspects, the techniques described herein relate to a method wherein the generation of a vibrationally exited nitrogen atom or nitrogen containing molecule by plasma is followed by an electrolytic reaction in a two-cell electrolytic reactor including an anolyte cell having an anode and a catholyte cell having a cathode, and an anolyte solution is recirculated.

In some aspects, the techniques described herein relate to a method wherein recirculated solution passes through a degasification chamber to produce an evaporated gas, optionally wherein said degasification chamber includes an ultrasonic probe.

In some aspects, the techniques described herein relate to a method wherein said degasification chamber has a largely spherical shape and wherein liquid enters and leaves the chamber in a tangential fashion to create a differential centripetal force on bubbles created in the liquid; and further, wherein gas is extracted along a liquid recirculation axis.

In some aspects, the techniques described herein relate to a method wherein said degasification chamber has a largely cylindrical shape and wherein liquid enters and leaves the chamber in a tangential fashion to create a differential centripetal force on bubbles created in the liquid; and further, wherein gas is extracted along a liquid recirculation axis.

In some aspects, the techniques described herein relate to a method wherein said differential centripetal force on said bubbles is between 0.5-10 g, and pressure within said chamber is between 1.0-6.0 Barg.

In some aspects, the techniques described herein relate to a method wherein a liquid inlet to said degasification chamber includes a sonitrode and a residence time of the liquid between the sonitrode and the degasification chamber is less than 1 second.

In some aspects, the techniques described herein relate to a method wherein the evaporated gas includes predominantly ammonia, nitric oxide and water vapor, or the evaporated gas includes predominantly ammonia and water vapor, regardless of a degasification method (degasification driven by pressure, heat, ultrasonic, or combination thereof).

In some aspects, the techniques described herein relate to a method wherein recirculated solution passes through a crystallization chamber that is held at a lower temperature than the anolyte cell.

In some aspects, the techniques described herein relate to a method wherein concentrations of ammonium ion, nitrate ion, and temperature are maintained to result in a precipitation of solid ammonium nitrate, optionally wherein said solid ammonium nitrate is separated from recycled liquor.

In some aspects, the techniques described herein relate to a method wherein recirculated solution passes through a crystallization chamber that is held at a lower temperature than the anolyte cell.

In some aspects, the techniques described herein relate to a method wherein the recirculated anolyte solution passes first through a degasification chamber and then through a crystallization chamber (series product removal).

In some aspects, the techniques described herein relate to a method wherein a product of degasification is substantially ammonia gas that is saturated with water vapor, and a product of crystallization is substantially ammonium nitrate.

In some aspects, the techniques described herein relate to a method wherein a temperature of degasification is higher than the temperature of crystallization, wherein an evaporation of ammonia during degasification substantially contributes to a heat removal requirement to achieve crystallization of solid ammonium nitrate.

In some aspects, the techniques described herein relate to a method wherein two independent recirculation paths are provided (parallel product removal), a first recirculation path which passes through a degasification chamber, and a second path which passes through a crystallization chamber, optionally wherein both paths return separately to the anolyte cell.

In some aspects, the techniques described herein relate to a method whereupon the first path, including degasified liquid, depleted of ammonia, returns to a location proximal to the anode, such as within 5 cm of the anode, thus creating a concentration gradient at the anode relative to a bulk solution in the anolyte cell which promotes production of ammonia while depressing production of ammonium and nitrate ions.

In some aspects, the techniques described herein relate to a method wherein a ratio of flowrates of the first recirculation path to second liquid recirculation path is adjusted up to increase a molar outflow of elemental nitrogen to elemental oxygen (i.e., increase an output ratio of ammonia to ammonium nitrate).

In some aspects, the techniques described herein relate to a method where the two independent recirculation paths are recombined and dispersed into the anolyte cell at a location in the reactor proximal to the anode, such as within 2 cm of the anode, thus promoting the production of ammonia, ammonium ion, and nitrate ion.

In some aspects, the techniques described herein relate to a method wherein the generation of a vibrationally exited nitrogen atom or nitrogen containing molecule by plasma in a plasma reactor is followed by an electrolytic reaction in a two cell electrolytic reactor including an anolyte cell having an anode and a catholyte cell having a cathode and catholyte solution, wherein gases from the anolyte cell and the catholyte cell are kept separated, wherein gas from the anolyte cell is recycled, and gas from the catholyte cell is removed.

In some aspects, the techniques described herein relate to a method wherein the recycled anolyte gas passes through a condenser at a temperature lower than the anolyte cell; whereupon condensate includes primarily liquid ammonia and water, optionally wherein said condensate liquid is removed as a product, optionally wherein said condenser is included of a fractional distillation column so that ammonia can be removed separately from other condensed gases.

In some aspects, the techniques described herein relate to a method wherein the recycled anolyte gas is combined with makeup reactant gases before the recycled anolyte gas enters a microplasma reactor.

In some aspects, the techniques described herein relate to a method wherein the makeup reactant gases includes a mixture including one or more or all of components of dry air, nitrogen, water vapor, and a noble gas.

In some aspects, the techniques described herein relate to a method wherein a molar flow rate of elemental nitrogen in the makeup reactant gases is substantially equivalent to a sum of molar outflow of elemental nitrogen in respective product streams.

In some aspects, the techniques described herein relate to a method wherein the noble gas is helium and is added in amounts <10% molar of total recycled gas to maintain a stable microplasma discharge.

In some aspects, the techniques described herein relate to a method wherein said anolyte cell and said catholyte cell are separated by a proton membrane which allows a conduction of protons (H+) from catholyte to anolyte and conduction of hydroxyl ions (OH−) from the anolyte to the catholyte but disallows flow of nitrate (NO3−), ammonia (NH3), and ammonium (NH4+) between the catholyte cell and anolyte cell.

In some aspects, the techniques described herein relate to a method wherein where a flow of pure water makeup is added to the catholyte cell or as water vapor to the recycled gas.

In some aspects, the techniques described herein relate to a method wherein a molar flow rate of elemental oxygen in the pure makeup water is substantially equivalent to or greater than the molar flow rate of elemental oxygen in oxygen gas which is generated at the cathode and subsequently exhausted.

In some aspects, the techniques described herein relate to a method wherein a metallic hydroxide is added to the catholyte solution to maintain good conductivity of the solution and promote evacuation of protons through a proton membrane, optionally wherein where the metallic hydroxide is potassium hydroxide.

In some aspects, the techniques described herein relate to a method wherein aqueous potassium hydroxide is added independently as a component to both the anolyte cell and catholyte cell.

In some aspects, the techniques described herein relate to a method wherein a liquid makeup stream including an aqueous solution of potassium hydroxide is added to an electrolyte chamber.

In some aspects, the techniques described herein relate to a method wherein a concentration of potassium ion and nitrate ion are such that, at a temperature of a crystallizer, predominantly potassium nitrate is a solid precipitant.

In some aspects, the techniques described herein relate to a method wherein an elemental potassium flow rate in the said liquid makeup stream is equal to an elemental potassium flow rate in a solid precipitant and, an elemental oxygen flow rate in said liquid makeup stream is equivalent to a combination of elemental oxygen flow rates of: said gas from the catholyte cell, plus said solid precipitant, minus said makeup gas streams.

In some aspects, the techniques described herein relate to a system for synthesis of ammonia from nitrogen and hydrogen, the system including: a first reaction chamber in which plasma is used to generate a vibrationally exited nitrogen atom or nitrogen containing molecule; and a second reaction chamber which is a two celled electrolytic reactor including an anolyte cell having an anode and a catholyte cell having a cathode, wherein excited gas from the first reaction chamber is injected into the anolyte cell.

In some aspects, the techniques described herein relate to a system wherein said plasma is a microjet plasma generated by RF energy conducted through a gas between two electrodes designated as an RF electrode and a GND electrode.

In some aspects, the techniques described herein relate to a system wherein a spacing between the two electrodes (gap including gas) is between 5 mm and 1 mm, and a gas pressure is between 0.8 Barg and 5 Barg.

In some aspects, the techniques described herein relate to a system where both electrodes include an alloy of at least 90% tungsten by weight.

In some aspects, the techniques described herein relate to a system wherein gas is configured to flow through an annulus where an outer surface of the annulus is a GND electrode, and an inner surface of the annulus is an RF electrode, resulting in a cross-sectional gas flow area determined by a radii of both electrodes (R1=GND radius; R2=RF radius), optionally wherein a length of RF electrode is substantially larger than a thickness of the GND electrode (L1=GND electrode thickness), resulting in a discharge volume that is proportional to (R1−R2)*L1, where R1−R2 is an effective electrode spacing.

In some aspects, the techniques described herein relate to a system wherein a gas from the first reaction chamber is configured to flow directly into a second reaction chamber wherein said second reaction chamber is a two celled electrolytic reactor including an anolyte cell having an anode and a catholyte cell having a cathode.

In some aspects, the techniques described herein relate to a system wherein the anode is substantially coated with an alloy including nickel.

In some aspects, the techniques described herein relate to a system further including a two-cell electrolytic reactor including an anolyte cell having an anode and a catholyte cell having a cathode, and an anolyte solution is configured to be recirculated.

In some aspects, the techniques described herein relate to a system wherein the recirculated solution is configured to pass through a degasification chamber to produce an evaporated gas, optionally wherein said degasification chamber includes an ultrasonic probe.

In some aspects, the techniques described herein relate to a system wherein said degasification chamber has a largely spherical shape and wherein liquid is configured to enter and leave the chamber in a tangential fashion to create a differential centripetal force on bubbles created in the liquid; and further, wherein gas is configured to be extracted along a liquid recirculation axis.

In some aspects, the techniques described herein relate to a system wherein said degasification chamber has a largely cylindrical shape and wherein liquid is configured to enter and leave the chamber in a tangential fashion to create a differential centripetal force on bubbles created in the liquid; and further, wherein gas is configured to be extracted along a liquid recirculation axis.

In some aspects, the techniques described herein relate to a system wherein a liquid inlet to said degasification chamber includes a sonitrode and a residence time of the liquid between the sonitrode and the degasification chamber is less than 1 second.

In some aspects, the techniques described herein relate to a system wherein recirculated solution is configured to pass through a crystallization chamber that is held at a lower temperature than the anolyte cell.

In some aspects, the techniques described herein relate to a system wherein two independent recirculation paths are provided (parallel product removal), a first recirculation path which passes through a degasification chamber, and a second path which passes through a crystallization chamber, optionally wherein both paths return separately to the anolyte cell.

In some aspects, the techniques described herein relate to a system wherein the two independent recirculation paths are recombined and dispersed into the anolyte cell at a location in the reactor proximal to the anode, such as within 2 cm of the anode, thus promoting the production of ammonia, ammonium ion, and nitrate ion.

In some aspects, the techniques described herein relate to a system wherein a plasma reactor is followed by a two cell electrolytic reactor including an anolyte cell having an anode and a catholyte cell having a cathode and catholyte solution, wherein gases from the anolyte cell and the catholyte cell are configured to be kept separated, wherein gas from the anolyte cell is configured to recycled, and gas from the catholyte cell is configured to be removed.

In some aspects, the techniques described herein relate to a system further including a condenser adapted to pass the recycled anolyte gas at a temperature lower than the anolyte cell; optionally wherein said condenser is included of a fractional distillation column so that ammonia can be removed separately from other condensed gases.

In some aspects, the techniques described herein relate to a system further including a microplasma reactor configured to receive the recycled anolyte gas combined with makeup reactant gases.

In some aspects, the techniques described herein relate to a system wherein said anolyte cell and said catholyte cell are separated by a proton membrane which allows a conduction of protons (H+) from catholyte to anolyte and conduction of hydroxyl ions (OH−) from the anolyte to the catholyte but disallows flow of nitrate (NO3−), ammonia (NH3), and ammonium (NH4+) between the catholyte cell and anolyte cell.

### BRIEF DESCRIPTION OF THE FIGURES

Exemplary embodiments of the disclosure will be described in more detail in the following description of the figures:

FIG. 1 shows a proposed microplasma reactor system.

FIG. 2 shows a proposed schematic of the plasma jet.

FIG. 3 shows a plasma jet configuration where plasma activated gas are injected from the bottom of the chamber and bubbles through a mesh anode.

FIG. 4 shows a plasma jet configuration where plasma activated gas are injected from the bottom of the chamber and bubbles through a layered composite mesh anode.

FIG. 5 shows a plasma jet configuration where plasma activated gas are injected from the bottom of the chamber and bubbles through a tubular catalytic anode with anolyte aspirating trough tailored holes at the bottom of the tubular catalytic anode.

FIG. 6 shows a plasma jet configuration where plasma activated gas are injected from the bottom of the chamber and bubbles through a tubular catalytic anode with a controlled lean anolyte injection into the tubular catalytic anode

FIG. 7 shows a top mounted plasma jet injecting plasma activated gas onto a catalytic mesh that is partially submerged in liquid.

FIG. 8 shows a top mounted plasma jet injecting plasma activated gas onto a catalytic mesh that is partially submerged in liquid with UV light enhancement of the liquid droplets.

FIG. 9 shows an acoustic ultrasound sphere for gas/liquid separation.

FIG. 10 shows an inline tube ultrasonic chamber for gas liquid separation.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

This disclosure provides ammonia synthesis methods and systems capable of producing ammonia in a continuous production process.

In some aspects, approaches such as the use of microplasma, UV proton enhancement, and in-situ electrolysis can be combined into a single reactor system, thus allowing the advantages of each individual method to be multiplied into a single process.

In some aspects, by constructing apparatus that allows for the continuous removal of pure product, the remaining unreacted reactants are recycled, enabling far superior conversion of reactants and intermediate species into valuable final products.

Some aspects of the disclosure improve reaction efficiency and enable the production of other valuable product streams, such as ammonium nitrate and potassium nitrate, in addition to the primary product of ammonia.

In some aspects, an attribute of the system is the dual closed recirculation loops of gas and liquid through a primary synthesis reactor. By adjusting inputs into these closed loops, along with operating conditions of the various subprocesses, the process can be pushed to achieve a variety of possible results.

### System Overview

In one aspect the disclosure relates to a method for the synthesis of ammonia from nitrogen and hydrogen, the method comprising use of plasma, such as a microjet plasma, in a first reaction chamber to generate a vibrationally exited nitrogen atom or nitrogen containing molecule, optionally wherein the excited nitrogen atom or molecule is reacted with hydrogen in an aqueous medium, optionally wherein the medium is then recycled to remove soluble products.

The plasma may be a generated in a first (plasma) reaction chamber by a plasma jet reactor, which may also be called a micro plasma reactor. A microplasma reactor suitably has plasma generated by RF energy conducted through a gas between two electrodes designated as an RF electrode and a GND electrode where the spacing between the electrodes (the gap containing the gas) is between 5 mm and 1 mm, and the gas pressure is between 0.8 Barg and 5 Barg.

The plasma reaction suitably ejects or otherwise provides reacted nitrogen gas into a liquid, such as an aqueous medium, and ammonia may be generated directly within the liquid at the surface of the anode through the reaction of the excited N species with aqueous protons.

The liquid containing products of the reacted excited nitrogen is recycled to remove soluble reacted products.

Features of the disclosure are described below.

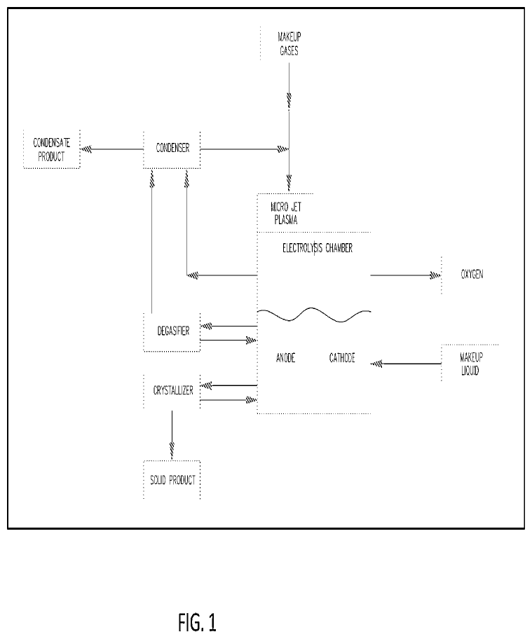

FIG. 1 presents a block flow diagram of a microplasma reactor system suitable for use in some aspects of the disclosure.

In some embodiments, the chemical gas inputs to the plasma reaction include, at a minimum, the elements of hydrogen and nitrogen, and in some embodiments, also include the compounds of air and water which contain the element of oxygen.

In some aspects, several subsystems, some with specific novel apparatus, are described herein which, alone or in combination with other subsystems, significantly enhance the performance and utility of the minimum system of plasma reactor with recycled liquid. For example, subsystems can include, without limitation, one or more of the following: a recycled gas loop, a nitrogen concentrator, an electrolysis reactor, a degasifier, a crystallizer, and a condenser.

In some embodiments, an electrolysis chamber is combined downstream to the plasma reactor to perform a second reaction in series with the plasma reaction. The anolyte liquid comes into contact with the reacted plasma gas, unreacted gas, and reacted intermediates. In some embodiments, the plasma gas is introduced to the anolyte chamber in a way that provides close proximity to anolyte liquid and a catalyst coated anode. Several manifestations of the apparatus are defined in subsequent sections, including apparatus that injects lean anolyte liquid directly into the path of the plasma reacted gas.

In some embodiments, the system of the first embodiment (a plasma reactor and downstream electrolysis chamber) is combined with a recycled gas stream, whereby plasma gases which are not reacted, as well as gases which are produced at the anode as part of the electrolysis reaction, such as hydrogen gas (H₂), are recovered and recycled back through the plasma reactor.

In some embodiments, the system is combined with a recycled gas stream (without the requirement of the electrolysis chamber of the 2^{nd} embodiment). Plasma gas is injected into a liquid where reacted products are dissolved, and undissolved gases are returned to the plasma reactor. This combination would be most useful when pure hydrogen and pure nitrogen are used as makeup gases to the gas recycle stream.

In some aspects, the disclosure comprises a two chambered electrolytic cell where the catholyte and anolyte chambers are separated by a proton membrane. The cathode (+) side of the cell emits oxygen gas (O₂) from a catalyst coated electrode. The anode (−) side of the cell absorbs protons from the anolyte solution and a reaction that may or may not produce gas takes place in its surface. The surface of the anode is coated with an alloy (suitably containing nickel) which catalyzes the ammonia synthesis reaction.

In some aspects, the anolyte chamber is coupled with plasma (eg a microjet plasma apparatus) as described below, as part of a system, whereby the plasma gas is injected in close proximity to the anolyte. Reaction gases in the anolyte chamber are contained and recirculated in a closed loop that recirculates back through the microjet plasma reactor. In the gas recirculation line, makeup reactant gases are added, and the gas is cooled in a condenser to control moisture content of the gas reactants and to extract liquid aqueous ammonia. In some embodiments, the condenser comprises of a fractional distillation column so that ammonia can be removed separately from other condensed gases. Liquid from the anode chamber (rich anolyte) is recirculated through a crystallizer and degasifier to remove reaction products as either solids (crystallizer, e.g., ammonium nitrate and/or potassium nitrate) or gases (degasifier, e.g., ammonia). Lean anolyte solution is returned to the anode side of the cell.

### Plasma Jet Reactor

In some embodiments, the plasma (which may be a microjet plasma) creates a high number of vibrationally exited nitrogen species that are close (in time proximity) to aqueous protons that are near the surface of a negatively charged catalyst (such as nickel) electrode. In some embodiments, this is accomplished by having nitrogen containing gas moving rapidly between two electrodes that are energized with radio frequency power at an electrode spacing, voltage, and gas pressure that is suitable to sustain a plasma discharge.

### Definition of Plasma Jet Terms

In some embodiments, as a simplified way to rationalize the features of the microjet plasma, the species of the plasma are categorized into the following:

Free electrons (F_{E})—these electrons are unbounded, and generally high energy, that absorb kinetic energy via acceleration with each oscillation of the RF electric field. To become unbounded from the gas molecules, the voltage of the field must exceed the breakdown voltage, U_{b}, of the gas. According to Paschen's Law, the U_{b} is chiefly proportional to gas pressure and electrode spacing. In order to sustain a plasma, the average free electron must collide to form at least one ion.

Plasma excited ions (I_{PE})— these are positively charged atoms or molecules. Ions, having much greater mass than electrons, cannot respond kinetically to the radio frequency like the electrons, so they are not the primary contributor to creating reactive species as they are moving slower and have less frequent collisions. I_{PE} also have relatively short lifetimes (nanoseconds) compared to other gas atoms and molecules (microseconds or longer) because their charge enables them to attract and “catch” electrons. Nevertheless, ions are very observable because, as they absorb electrons, they give off photons of light; hence, they become an important component in theoretical modelling of reactive plasma.

Vibrationally enhanced molecules (M_{VE})— These are molecules that are normally stable which have an absorbed quanta of energy from the collision with another excited specie, such as a free electron. A good way to think about M_{VE} is that they are “ready” to react—more ready than if it were not excited. This is very important for ammonia synthesis because the traditional way to get nitrogen ready to react is to heat it up to very high temperature and pressure. With this disclosure, it is the quantity and the efficiency by which M_{VE} are delivered to the catalytic anode that will determine the economic viability of the implementation. If M_{VE} are not given the opportunity to react, then the additional energy to create them will dissipate and simply contribute to increasing the temperature of its surroundings.

### Plasma Jet Electrode Configuration

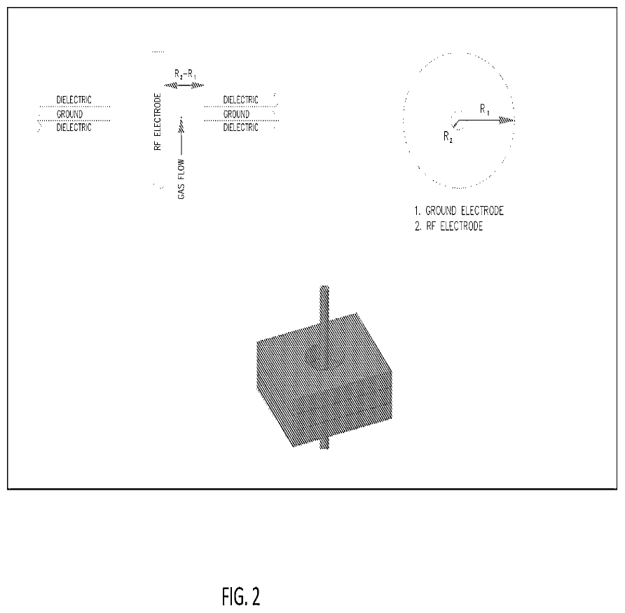

FIG. 2 presents a drawing of a plasma jet configuration in some aspects of the disclosure. The significance of the dimensions is further discussed in this section. In some embodiments, the RF electrode may be comprised of a small radius cylinder, or stiff wire, of size (R₂) and resistance needed to carry the power of the microjet without overheating. In some embodiments, industrial scale electrodes made from alloys of tungsten would be suitable for this purpose, and are readily available in diameters less than 1 mm, and lengths of up to several cm.

The ground electrode (GND) may be comprised of a plate of a certain thickness (L₁) with a hole cut into it of a certain radius (R₁). In some embodiments, for at least a few cms surrounding the hole, the GND electrode is covered with a dielectric on both sides to prevent the RF energy from arcing anywhere other than the exposed surface of the side of the hole.

The RF electrode is suitably positioned within the center of the hole in the GND electrode and may protrude beyond the hole. The resulting position creates a zone of intense RF field that has a volume (F_{V}) given in Equation 3-1:

Fᵥ=π×(R₁−R₂)²×L₁ (3-1)

The ideal spacing between the electrodes (R₁−R₂) is bounded by these conditions:

The efficiency and capability of equipment to deliver higher voltage RF.

The energy required to drive reactive gas through a smaller hole.

The mechanical ability and cost to keep a narrow wire centered in a fairly narrow hole.

From literature it is known that large gaps require prohibitively high voltage and are difficult to contain. Typical gaps reported are the proximity of a few mm. Likewise, it is known from practice, that high volumes of gas can be delivered through holes that that have a diameter of mere mm. One good reason for the use of tungsten as the material for the RF electrode, is that it is very stiff. As a result, the following nominal reactor dimensions are recommended and given in Equation 3-2:

R₁<0.5 mm

1.5 mm<R₂<2.5 mm (3-2)

The thickness of the GND electrode, L₁, along with the velocity of the gas through the intense RF field F_{V}, determines the residence time of the gas. For this application, faster gas flow is better because it will deliver excited species sooner to the catalyst on the anode. However, it is believed that there will be practical mechanical limits as gas speeds within the F_{V} approach the speed of sound. As a result, it is recommended that gas velocities (V_{FV}) in the F_{V} should be maintained between Mach 0.1-0.9. This recommendation is mathematically given in Equation 3-3.

Mach 0.1<V_{FV}<Mach 0.9 (3-3)

### Joining Plasma Jet and Anolyte Electrolysis Reaction Chambers

Several configurations are envisioned for joining the plasma jet reactor to the anolyte chamber. One of the goals is to get large quantities of vibrationally enhanced molecules, V_{ME}, to a catalyst covered anode that is coated (or submerged) in an anolyte solution within an electrolytic chamber.

### Problems with Prior Art

Some prior art injects the plasma gas into the base of an anolyte chamber, and others spray the plasma gas onto the top surface of a liquid surface. In these cases, catalytic coated electrode is submerged within the chamber. The problem with this approach is that activated plasma gas is separated from the electrode by about a cm or several cm's of liquid, and since the diffusion rate of species in liquid is on the order of 1/1000^{th} the diffusion rate in a gas, most of the excited species never make it to the catalyst. This results in a much lower V_{ME} flux than could be achieved if the V_{ME} could be delivered in the gas phase and only have to travel 1 mm or less in the liquid phase to reach the catalyst.

Some prior art is focused on synthesis of ammonia exclusively in the vapor phase. The problem with this approach is that it is desirable and cost effective to deliver hydrogen to the reaction in the form of water, or as a second preference in the form of hydrogen gas. The problem with this approach is that a much larger fraction of the plasma energy goes into producing activated water and hydrogen, rather than activated nitrogen (due to the stronger triple bond of nitrogen gas). A second problem with using vapor phase only, is that products of the reaction are not recovered in a liquid phase, which has much higher capacity to contain them economically.

Plasma Jet Bottom Injection with Mesh Anode

In some configurations the activated plasma gas is injected from the bottom into a chamber containing anolyte solution and a submerged catalyst coated anode.

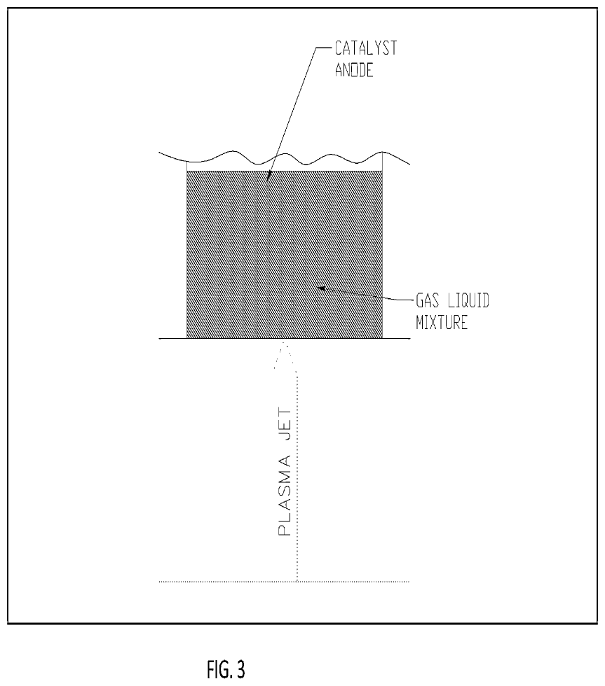

In some configurations, as presented in FIG. 3, the anode may be a catalyst coated wire mesh that is submerged in anolyte. The gas, being at high velocity, churns rapidly up through the liquid. An advantage of this configuration is the simple nature of the configuration. If desired a wire mesh could be layered and shaped to create a profile that matches the gas stream fluid dynamics to make the gas/liquid/catalyst contact more uniform. A wire mesh can be a composite of stronger thicker components mixed with finer components that have a larger catalyst surface area such as amorphous silica, activated carbons and zeolites.

### Composite Catalyst Electrode

In some embodiments, one possibility for layering, or composite, would be to have a lower layer, or 2^{nd} catalytic material. For example, having a 2^{nd} material comprised of glass (SiO₂) would promote the production of NO₃ over NH₃, if it were desired to have more nitrate solids.

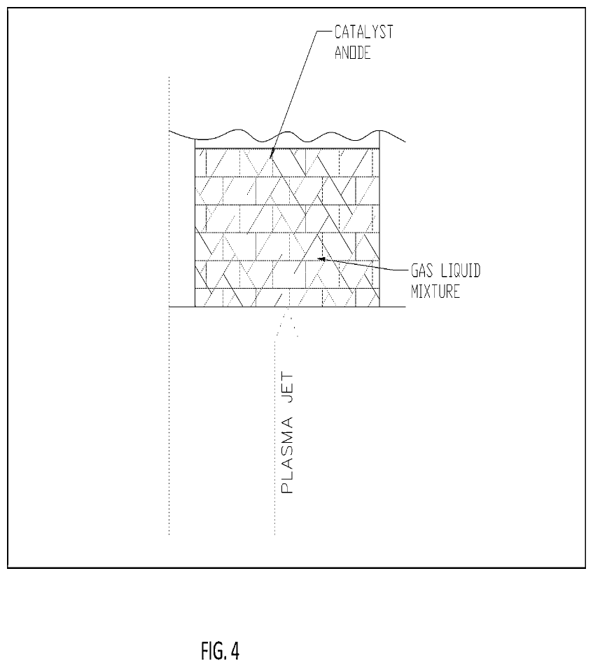

The configuration presented in FIG. 4 lends itself to easily implement multiple plasma jets, and some aspects the disclosure uses such an array of plasma jets which can be configured in a gas plenum below the anolyte chamber and have anodes configured as composite mats. This would be a straightforward method to scale for mass production.

### Tubular Catalytic Anode

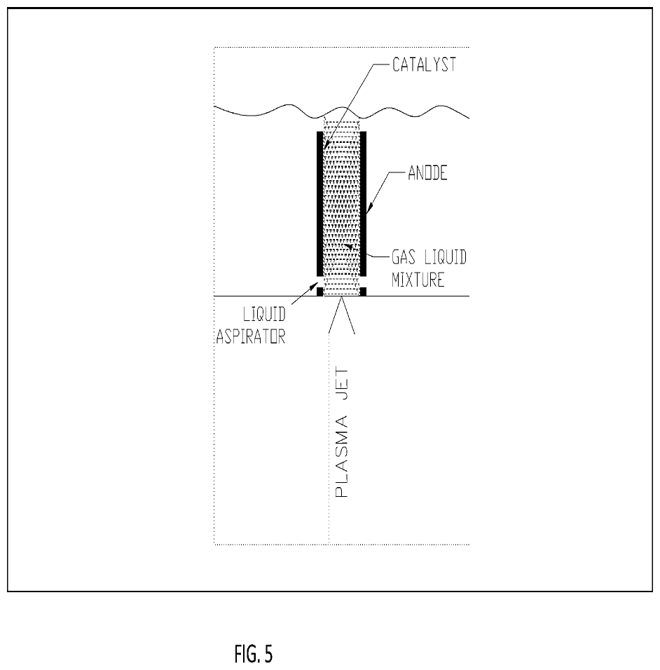

In a configuration presented in FIG. 5, the plasma jet may be injected into a tube that extends up to near the surface of the anolyte liquid. The walls of the tube are coated with a catalyst. Holes are made near the base of the tube that allow anolyte liquid to be aspirated into the tube.

Several parameters would determine how much liquid gets combined with the gas, including, without limitation, one or more of the following:

The gas flow rate

Head pressure of liquid (depth)

Diameter of the tube

Diameter and shape of the aspirator hole

Viscosity of the anolyte solution

Wall thickness of the tube

In some embodiments, similar to the configuration displayed in FIG. 3, the tube can be packed with a catalytic wire mesh, with layering and composite, to tailor the reaction results. This configuration also allows higher gas to liquid ratios to be achieved since the liquid is restricted from entering the tube. The amount of liquid that does enter, however, would be hard coded into the apparatus, with the flow being dependent on the variables listed above, with the only dynamic knob being gas flow rate. An advantage over the mesh anode configuration given in FIG. 3, is that the gas/liquid ratio could be changed with hardware, and that the reactor would be simpler to model.

Lean Anolyte Injection with Tubular Analytic Anode

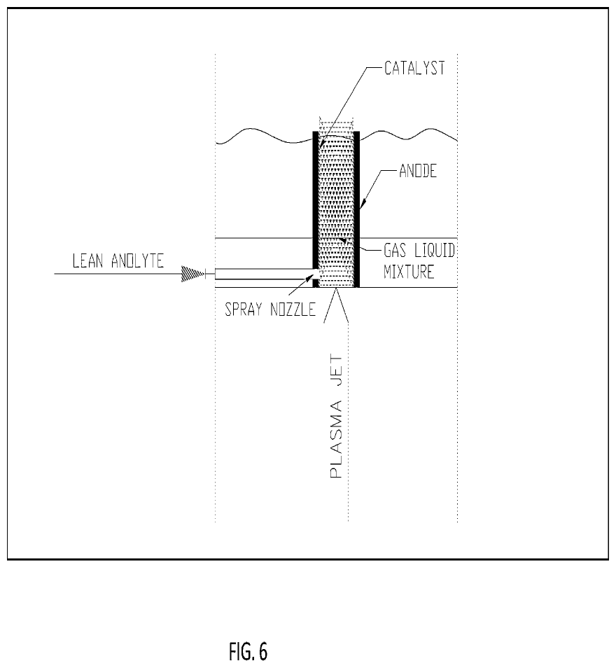

The configuration displayed in FIG. 6 would allow only lean anolyte to be injected into the tube. This would increase the concentration gradient for the reaction, which will force the reaction rate to be faster. In this configuration, the tubular catalytic anode as described in the previous section is used, but the aspirator is replaced with a separate lean anolyte feed line that is plumbed into a spray nozzle located at the base of the catalytic anode tube just downstream of the plasma gas injection point.

In a full reactor configuration, such as presented in FIG. 1, the lean anolyte is routed to the plasma jet as a portion of the return line of anolyte coming from the degasifier and condenser. These return lines have been depleted of ammonia and nitrate salts and therefore would be ideal to mix with the plasma jet gas. Ideally, the flow through the lines that feeds the plasma jets would only comprise a portion of the returning liquid in order to make the flow rate independent of the recycle loop flow rates Also, by making it a separate line, the pressure could be boosted in order to optimize the atomization distribution of the spray nozzle, further increasing control within the gas/liquid/solid area. The hardware for this method is more complex and costly as it requires tubing to be routed to each of the plasma jets, and it would require additional piping and an additional booster pump. As shown in the above diagram the gas and liquid both exit the tube above the liquid level of the chamber. The gas velocity would need to be sufficient to blow the liquid out of the top to prevent liquid from flooding back in, which is important for higher gas/liquid ratios to prevent flooding.

Top Spray Plasma Jet with Mesh Catalytic Anode

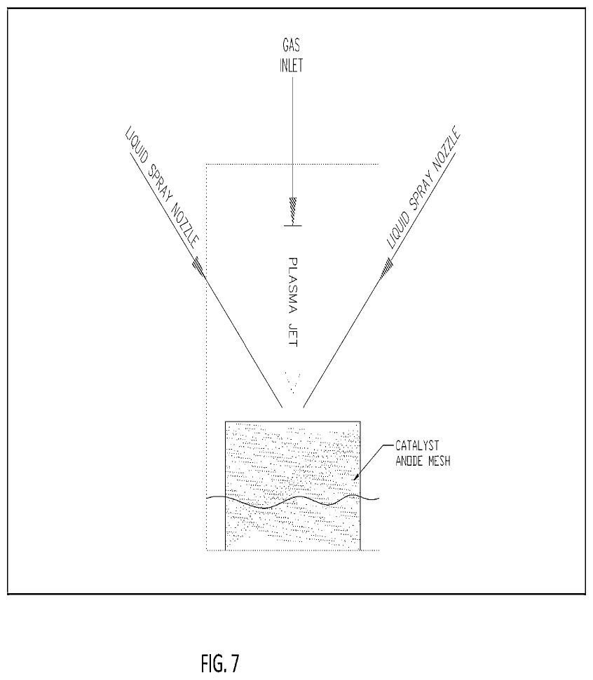

In the configuration presented in FIG. 7 a plasma jet is mounted at the top of the anode chamber and the excited gas is injected downward toward a catalytic mesh anode. Lean anolyte is sprayed into the chamber in the vicinity of the plasma jet, and rains down onto the catalyst anode mesh. The lower part of the anode mesh is submerged in anolyte that is collected to keep the anolyte and the plasma mesh at equal electric potential.

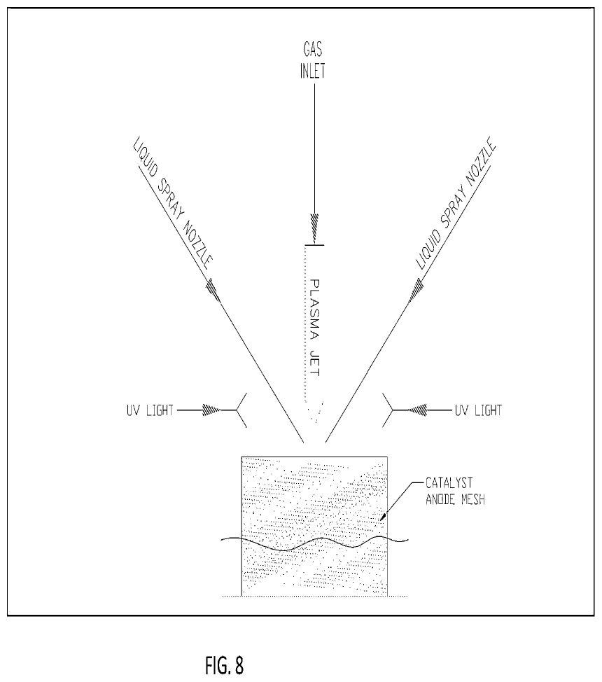

In some embodiments, a variation on this configuration, as presented in FIG. 8, is the addition of UV lights to the vapor spray cavity. This will increase proton formation, which will increase the formation of ammonium. The UV light could also be easily modulated in intensity to control the amount of ammonium formation.

In some embodiments, the vapor spray cavity comprises one or more UV light sources which suitably may be modulated in intensity.

In some embodiments, the configurations that inject lean anolyte solution have an advantage in that all of the gas that strikes the catalyst mesh is saturated with lean anolyte droplets. This will reduce the tendency for salt precipitation. The plasma gas is potentially very dry and will tend to pull water out of the liquid phase, and if it combines with rich anolyte solution it may cause salt precipitation.

### Ancillary Processes

Ancillary processes can be those that define a complete system. In some embodiments, ancillary processes can include, without limitation, one or more of the following:

Cathode electrolysis and proton membrane

Degasification

Condenser

Crystallization

Nitrogen concentrator

### Cathode Electrolysis and Proton Membrane

In some aspects the electrolysis chamber has a proton membrane to separate the cathode and anode.

In some embodiments, the cathode electrolysis converts aqueous oxygen into oxygen gas and evacuate it from the system. Some aspects of the disclosure uses cathode electrolysis in exactly the same fashion that electrolysis of water produces oxygen on the cathode, and hydrogen gas on the anode. The electrolyte solution, or catholyte, can have a different chemistry from the anode chamber if the chambers are separated by a membrane. In some embodiments, one configuration is proposed that separates the chambers with a proton membrane. This allows the chemistry in the cathode chamber to be substantially different from the chemistry in the anode chamber. The degree of differences which are allowed depend heavily on the specific materials and performance specifications of the membrane. Membranes can be designed to enhance/prevent the transfer of specific ions and cations between the anolyte and catholyte chambers. At a minimum, however, the membrane must transmit the flow of electrons from anode to cathode, and the flow of protons from cathode to anode. Using this disclosure, specialized membranes can be employed to achieve desired results.

In some aspects of the disclosure, the catholyte chamber evacuates oxygen gas from the surface of a catalytic cathode and evacuate protons through the proton membrane into the anode chamber.

In some aspects of the disclosure, the cathode chamber is also the entry point of the primary reaction water. Water brings the hydrogen that will form the ammonia. So, the hydrogen has to dissociate from the water molecule (which it does at the positively charged cathode), and then migrate through the membrane, and eventually react in the plasma and anode chamber to form ammonia and ammonium (as discussed previously and in the literature).

In some aspects, cathodic expiration of oxygen gas in the water is the only escape route for oxygen from the system, that is used to provide the hydrogen (aside from a bleed of liquid to waste). The only other way out for oxygen is through the crystallization products of ammonium nitrate or potassium nitrate, which must be equal to the oxygen in the makeup gas (aside from a bleed stream).

In some aspects, protons which migrate through the proton membrane are the only source of protons to the system (unless water is added to the anolyte chamber, which is likely needed from time to time to maintain balance in the system), and therefore must match the hydrogen in the products which are evacuated from the anode side of the system (through solids ammonium nitrate, potassium nitrate, and aqueous ammonia).

In an alternative embodiment of this disclosure, potassium hydroxide will be added to the cathode chamber as needed to maintain robust conductivity and pH. The proton membrane can be designed to minimize potassium from going into the anolyte chamber. Since potassium cannot make a volatile gas, it provides a way to improve the conductivity of the catholyte, increasing electrolysis performance.

### Degasification

In some aspects the system comprises the use of ultrasound to remove ammonia.

In some embodiments, a degasification unit removes ammonia from the rich anolyte that is being recycled for the purpose of having the ammonia removed. The traditional way of accomplishing this would be to heat the liquid to reduce the solubility of the ammonia. While this is likely practical, and conventional equipment can be used for that purpose, a more energy efficient method is proposed in some embodiments, which is the use of ultrasonic sound waves to degasify at the same temperature of the anolyte chamber.

Prior art demonstrates that ultrasonic sound waves can be an effective way to accelerate the removal of ammonia from aqueous liquids; however, these applications were demonstrated for purposes such as removing ammonia from wastewater, not for the purposes of production of ammonia. In the prior art examples, ammonia is being expelled into essentially an infinitely dilute gas, so that once the gas leaves the liquid, there is no concentration gradient in the vapor to drive it back into the liquid. In some embodiments, the vapor phase is concentrated ammonia vapor so that it can be recovered as a product. Hence, in some aspects of the disclosure the ammonia vapor should be separated from the aqueous liquid as soon as possible to prevent it from re-dissolving.

Primary driving forces for redissolution of ammonia can include, without limitation, one or more of the following:

Mass transfer kinetics at the vapor liquid interface

Surface area of the gas liquid interface

Temperature

Pressure

Ammonia concentration in the vapor phase

Ammonia concentration in the liquid phase

In the case of ultrasonic energy, typical degasification processes run at energy level sufficient to cause cavitation, which forms tiny bubbles in the liquid. In these applications, as the bubbles rise, they coalesce and form larger bubbles, whereby the surface area of the bubble compared to the mass inside the bubble becomes much smaller which forces the bubbles of pure gas to rise out of the liquid before they can be redissolved back into the liquid.

In some embodiments of the disclosure, the ultrasonic energy is used within a liquid environment that is rotating, thus increasing centripetal forces. This is proposed to increase the driving force, along with gravity, to remove the bubbles from the liquid. Bubbles rise from liquid by the force of gravity acting on the relatively lower density of the gas bubble relative to the density of the liquid around the gas bubble. The velocity with which a gas bubble rises is dependent upon the viscosity of the liquid, with high viscosity causing bubbles to rise slower (which in this case gives them more time to dissolve). Generally, as bubbles rise, they grow in size due to decreased head pressure, however in this application, the gas in the bubble will want to redissolve into the liquid when ultrasonic forces are removed.

Bubbles also grow significantly when they coalesce with nearby bubbles. If surface tension of the liquid is low, bubbles will combine when they collide, forming a bigger bubble. As bubbles collide, the ratio of surface area to the mass of gas inside the bubble decreases logarithmically with the radii of the bubbles, which greatly reduces the rate at which the mass in the bubbles redissolves. Hence, it is very advantageous in the degasification process if bubbles are forced to move toward each other.

Ultrasound waves in liquid reflect from solid surfaces in a similar way that sound waves in air reflect from solid surfaces, specifically, that they can be directed to a focal point where a signal can be amplified. When the geometry of the solid surface is circular, the arc of the surface acts to focus the energy to the center of the circle. As sound strikes a wall, some of it is reflected, while some is absorbed by the wall. This is because sound travelling at low incident angle will collide more frequently and dissipate faster, whereas sound at high incident angle (eg, 60-90 degrees) will travel longer distances as they traverse near the center. The amount that is absorbed is a function of the material, the frequency, and incidence angle.

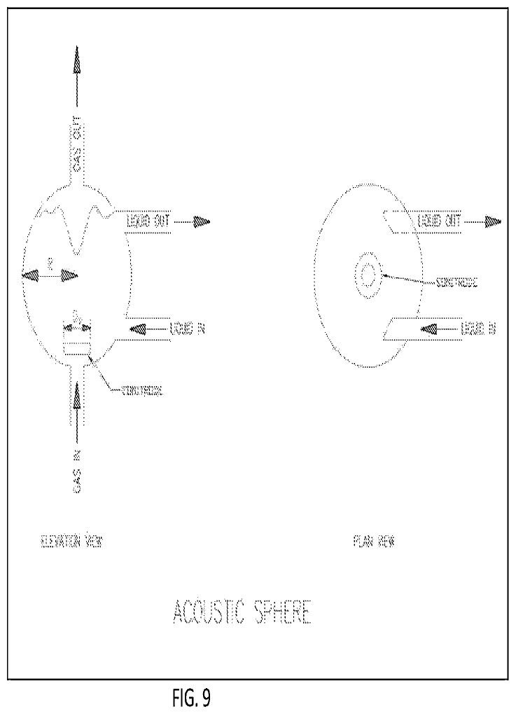

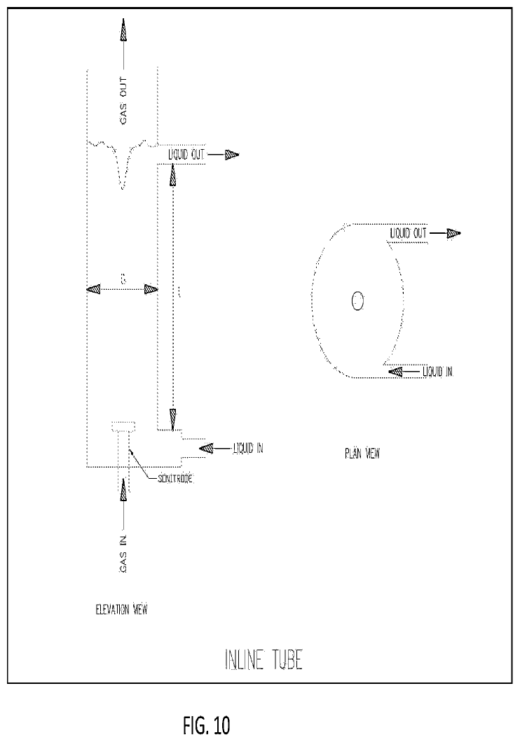

This disclosure proposes two apparatus configurations, FIG. 9 and FIG. 10 that causes cavitation bubbles to form, coalesce, and accelerate toward the gas/liquid interface at prescribed locations within a liquid when ultrasonic energy is applied.

In some embodiments, liquid enters the acoustic sphere at a tangent to the surface of the sphere, in some embodiments, at or near to the bottom of the sphere, in some embodiments, at approximately the same elevation as the surface of a sonitrode that is mounted from the bottom. The liquid suitably exits from the top portion of the sphere in a tangential orientation in a direction similar to the liquid inlet so that the liquid exits without increasing turbulence. Pipe diameter and liquid flow rate are designed to induce the formation of a vortex at the top of the liquid. The centripetal force of the liquid guides the bubbles formed from ultrasonic cavitation to move and coalesce along the center vertical axis. The ultrasound waves are also reflected and focused on the center of the chamber promoting cavitation at the center compared to the outer surfaces.

Another embodiment of the ultrasonic degasifier uses a tube instead of a sphere. The same principles apply in that the centripetal force of the liquid causes cavitation gas bubbles to move toward and coalesce along the vertical axis. The same principle also applies that the sound will be focused; however, in the case of the tube, the sound will be focused along an axis rather than at a point.

### Condenser

In some embodiments, the system comprises a condenser. In some aspects of the disclosure, a cryogenic condenser may have one or two independent purposes. First, it is used to cool the degasified ammonia and separate it from other soluble gases that may have come from the degasification unit. Second, the condenser is used to cool the recycled gas from the anolyte chamber to control the humidity and ammonia content of the gas going into the plasma reactor.

Other gases, such as NO and NO₂ may be present in the recycled gas stream. If the condenser is comprised of a fractional distillation column, then these gases can be separately removed.

### Crystallization

In some embodiments, the system includes a crystallisation step. In some embodiments, a crystallization step is used to remove solid products from the system, specifically, either ammonium nitrate or potassium nitrate. Conventional equipment is used for this process, whereby the temperature of the rich anolyte liquid stream is rapidly lowered below the saturation temperature of the aqueous salt, forming a slurry of solid crystals. The crystals are then removed by a conventional separation process such as filtration, hydro cyclone, or centrifuge.

In some embodiments, a crystallization chamber may also have support equipment before and after the crystallizer to prepare the liquid for crystallization and to prepare the liquid for return to the electrolysis reactor. Such equipment can include heat exchanger, dewatering, and drying equipment for the solids processing.

### Nitrogen Concentrator

In some embodiments, the system comprises the use of dry filtered air as a primary feedstock.

Air contains approximately 20% oxygen and 80% nitrogen. Air may contain too much oxygen to get the desired result from the plasma jet reactor (depending on the product mix). Specifically, too much oxygen in the makeup gas can cause a disproportionate amount of NOₓ species to be formed in the plasma jet. In order to regulate the amount of oxygen in the makeup gas, nitrogen concentration is increased on a portion of the incoming air.

Conventional methods are available to perform nitrogen concentration increase. In some embodiments, an economical method currently used at high volume is cryogenic cooling the air to a temperature that liquifies and removes the oxygen. This process is relatively expensive in terms of the energy that is required, so it could be applied only to the fraction of air needed to reduce the oxygen content of the makeup gas to the desired level.

### Mass Balance Attributes

### Two Element Reaction Configurations, N, H

Some embodiments of this disclosure would use only pure hydrogen gas, H₂, and pure nitrogen gas, N₂, to produce ammonia, NH₃, in the plasma jet, according to the overall balanced equation given in Equation 3-4:

N₂+3H₂↔2NH₃ (3-4)

The apparent simplicity of a reaction that only contains two elements, however, is misleading. In this configuration, the electrolysis chamber would be used to make the H₂ gas, which can be cooled in the condenser to remove water vapor. If water vapor isn't removed, then the oxygen in the water will react and form NOₓ species in the plasma.

The conversion of hydrogen to ammonia will not be 100%, so the exiting gas from the plasma jet can be run through the condenser unit to remove the NH₃ product. The gas exiting the plasma jet would bypass the electrolysis cell and go directly to the condenser. The leftover pure N₂ and H₂ could then be recycled back into the plasma jet as described.

In some embodiments, other ancillary equipment could be operated at the limit of capability. In some embodiments, the nitrogen concentrator would have to remove all of the oxygen from the air, so that only pure N₂ goes into the makeup gas for the plasma jet. In some embodiments, the catholyte chamber would have to remove all of the oxygen from the water.

In some aspects, the disclosure could be used this way, and it would work to produce ammonia; however, the energy penalty to separate oxygen and prevent the formation of NOₓ may be less efficient than other configurations, and the overall production rate of ammonia may be lower than other configurations.

### Three Element Reactions, N, H, & O

Prior art demonstrates that adding water vapor to the N₂/H₂ plasma will increase the production rate of NH₃; however, it also produces NOₓ species. Prior art also demonstrates that adding 02 to the N₂/H₂ plasma greatly increases the formation of NOₓ species. If the ammonia synthesis takes place only in plasma while using any form of oxygen, then the formation of NOₓ will be very difficult to address. In some embodiments of this disclosure, the N, H, O products from the plasma are directly injected into anolyte solution.

In some embodiments, aqueous solutions offer a pathway to accommodate oxygen species, particularly NO₃, which have relatively high solubility compared to H₂, N₂, O₂, and NO₂; and also provides a highly soluble reservoir for NH₃. In other words, the anolyte solution provides a pathway to evacuate NOₓ and NH₃ from the plasma gas. In addition, the anolyte cell can promote the formation of ammonium, NH₄⁺, which can pair with NO₃⁻ to form the valuable chemical ammonium nitrate NH₄NO₃, which is highly soluble in aqueous solutions. Hence, a pathway to form (plasma+electrolysis) products in the aqueous anolyte solution according to the balanced overall equation presented in Equation 3-5:

9H₂O+4N₂→2NH₃+3NH₄NO₃ (3-5)

Some embodiments of the disclosure could be established whereby purified nitrogen from the air is combined with water that enters only through an electrolysis chamber. Recycled gas from the electrolysis chamber is entrained with water vapor so that NH₃ and NOₓ form in the plasma. The reacted plasma gases are then injected back into the anolyte chamber to form NH₃, as well as NH4⁺ and NO₃⁻ ions such as way that NH₃ and NH₄NO₃ form in stoichiometric proportions to Equation 3-5 (i.e., the only pathway for oxygen to enter the system or exit the system is the water added to the electrolysis chamber). If a chemical plant were operated in this condition, it would produce 7 tons of ammonium nitrate per 1 ton ammonia.

In some embodiments, however, if a fraction of O₂ is allowed to stay in the purified air, while an equivalent amount of O₂ is evacuated via the catholyte cell, then the stoichiometric production of NH₃ and NH₄NO₃ would be the same, yet the energy expenditure to purify the nitrogen would be greatly reduced. The reaction would remain balanced if equal molar amounts of oxygen were added through the makeup gas as were subtracted from the catholyte chamber (i.e., this would maintain a stoichiometric ratio of 2:3 of NH₃:NH₄NO₃). However, if the molar amounts added were not equal, then it will shift the ratio of the products in the favor of NH₃ when more oxygen is removed than is added, and likewise, if less oxygen is removed, then it would shift the reaction in favor of more NH₄NO₃ production.

Some embodiments of the disclosure can also increase efficiency and shift the ratio of products. For example, UV light is used to create more protons in the electrolytic reaction. This promotes the formation of the NH₄⁺ ion, which in turn allows the dissolution of more NO₃⁻ into solution (since the solubility of each of these ions increases in the presence of the other ion). This would increase the overall efficiency because it would allow the anolyte solution to store more total salt, thus amortizing the performance of the related ancillary equipment over a higher molar flow of product. For example, if the process required water to be evaporated in order to crystallize the ammonium nitrate, then a higher concentration of salt would reduce the evaporation requirements. Similar improvement in heat savings would also be realized with higher anolyte salt concentrations.

The features that are provided in some aspects of the disclosure allow the operator to “steer” the reaction toward different objectives. In general, the more knobs that the chemical plant operator has to steer the reactions in one direction or another, the higher the likelihood that the plant will be able to maintain peak performance under a wider range of demands and conditions.

### Water and Air as Primary Inputs

In some embodiments, the new ammonia synthesis process produces ammonia and ammonium nitrate using only water and air as inputs, without concentrating the nitrogen. In some embodiments, a fictitious molecule “N₄O” (which represents the stoichiometric ratio of nitrogen to oxygen in air) following the ideal equation given in Equation 3-6, would produce NH₄NO₃ and NH₃ from water and air.

17H₂O+4N₄O→2NH₃+7NH₄NO₃ (3-6)

In some embodiments, 17 mols of water combined with 4 mols of air would yield 2 mols of ammonia and 7 mols of ammonium nitrate. Since the molecular mass of ammonia is 17 g/mol, and the mass of ammonium nitrate is 80 g/mol, this would translate into chemical plant that produces 16.5 tons of ammonium nitrate per 1 ton of ammonia.

### Managing the Oxygen

Enumerable scenarios can be run with different assumptions of how to manage the oxygen. In some embodiments, if one wants to make ammonia, then one wants to cheaply get rid of the oxygen. In some embodiments, a logical way to recover the cost of making the oxygen is to make a saleable product that has a high demand and is low cost to store and transport. Ammonium nitrate meets that expectation, except in the limit of a “hydrogen economy’, where the demand for ammonia as a transport vehicle for hydrogen fuel would be far larger than the demand for ammonia fertilizer. This disclosure, however, offers more alternatives.

### Four Element Reactions N, H, O, and K

In some embodiments of the use of the system, adding aqueous solutions of potassium hydroxide, KOH, as the makeup liquid to the electrolytic chamber is proposed. The advantage of adding KOH, is that it is a way of adding K⁺, a non-volatile metallic ion that would participate in the liquid phase chemistry, but would not affect the plasma chemistry. In some embodiments, K⁺ would substitute for the NH₄⁺, reducing the demand for positive ions that can combine with the NO₃⁺ that provides a home for excited NOₓ species that come from the plasma. This way, more protons (H⁺) become available to form NH₃. The salt product that would form under this scenario would be potassium nitrate, KNO₃.

KNO₃ is an important chemical used to produce potassium fertilizer (the “K’ in NPK for agrarians). It is also a primary component of gunpowder, but by itself is very safe and has a near neutral pH of about 6.2. It also has a significant but lower solubility in aqueous solutions from its counterpart in this discussion (NH₄NO₃). KNO₃ has a molar mass of 101 g/mol. In an idealistic balanced equation, given in Equation 3-7, the use of KNO₃ in some embodiments would be:

6H₂O+3KOH+4N₂→5NH₃+3KNO₃ (3-7)

This equation describes the scenario where water and KOH were the only sources of oxygen into the system. Such a plant would produce 3.56 tons of KNO₃ per 1 ton of ammonia.

### Addition of Noble Gases.

In some embodiments, the addition of helium, He, or argon, Ar, to the plasma jet makeup gases are beneficial to maintaining a consistent plasma discharge. In some embodiments, helium is used due to its extremely low solubility in liquids. Helium can also be used as a marker to identify gas leaks in an apparatus.

In some embodiments, the methods of the present disclosure include:

A method for the synthesis of ammonia from nitrogen and hydrogen, the method comprising use of plasma, such as a microjet plasma, in a first reaction chamber to generate a vibrationally exited nitrogen atom or nitrogen containing molecule, optionally wherein the excited nitrogen atom or molecule is reacted with hydrogen in an aqueous medium, optionally wherein the medium is then recycled to remove soluble products, wherein the gas from the first (plasma) reaction chamber flows directly into a 2^{nd} reaction chamber whereby said 2^{nd} reaction chamber is a two celled electrolytic reactor comprising an anolyte cell having an anode and a catholyte cell having a cathode.

Some aspects of the method and apparatus or system include one or more of the following: (i) the excited gas from the 1^{st} microjet plasma reactor is injected into the anolyte cell in close proximity to the anode, such has within 5 cm of the anode; (ii) the anode structure contains activated carbon; and/or the anode structure contains zeolite, and/or the anode surface is substantially coated with an alloy containing nickel, and/or the anode structure is substantially impregnated with an alloy containing nickel. The anode structure may comprise a composite that contains a 1^{st} surface containing nickel and a 2^{nd} surface containing amorphous silica.

In some embodiments, the gas flow rate is sufficient for the gas to reach the anode within 1 second.

In some embodiments, the plasma gas enters the anolyte chamber through an orifice at the base of the anolyte chamber and the anode is positioned directly above the orifice and the anode is submerged in the anolyte liquid, allowing the plasma gas to mix with the anolyte liquid in the presence of the anode surface as the gas rises.

In some embodiments, the anode is confined to a solid cylinder with a hole at the base of the cylinder, adjacent to the orifice where the plasma gas enters, that allows the anolyte solution only to enter the cylinder through the hole. The diameter of the cylinder may be between 2-10 cm, and the hole is between 0.5-3 mm.

In some embodiments, the anolyte solution is recirculated.

In some embodiments, the anode is partially submerged in the anolyte solution and the plasma gas enters the anolyte chamber from the top directly above the anode within a distance of less than 10 cm and whereby the anolyte solution is sprayed through a nozzle onto the portion of the anode that is exposed to the plasma gas.

In some embodiments, a returning anolyte solution is sprayed into the cylinder through a nozzle positioned on the hole at the base of the cylinder, such that anolyte solution returning from recirculation is injected into the anolyte chamber via the hole at the base of that anode cylinder.

In some embodiments, anolyte solution is pressurized to 1.5 to 10 barg prior to the injection nozzle.

### Apparatus and Systems

Some aspects of the disclosure also relates to a system for the synthesis of ammonia from nitrogen and hydrogen, the system comprising a first reaction chamber in which plasma is used to generate a vibrationally exited nitrogen atom or nitrogen containing molecule; and a second reaction chamber which is a two celled electrolytic reactor comprising an anolyte cell having an anode and a catholyte cell having a cathode, wherein the excited gas from the 1^{St} reaction chamber is injected into the anolyte cell.

In some embodiments, the first and second reaction chamber may have any feature as disclosed in the methods herein. For example, the first chamber comprises microjet plasma generation means by RF energy conducted through a gas between two electrodes designated as an RF electrode and a GND electrode. The spacing between the electrodes (gap containing gas) may be between 5 mm and 1 mm, and the gas pressure is between 0.8 Barg and 5 Barg.

Both electrodes may be comprised of an alloy of at least 90% tungsten by weight.

In some embodiments, the gas flows through an annulus where the outer surface of the annulus is the GND electrode, and the inner surface of the annulus is the RF electrode, the resulting cross-sectional gas flow area being determined by the radii of both electrodes (R₁=GND radius; R2=RF radius), optionally wherein the length of RF electrode is substantially larger than the thickness of the GND electrode (L₁=GND electrode thickness), resulting in a discharge volume that is proportional to (R₁−R₂)*L₁, where R₁−R₂ is the effective electrode spacing.

In some embodiments, the first and second chamber are configured such that gas from the first (plasma) reaction chamber flows directly into the 2^{nd} reaction chamber which is a two celled electrolytic reactor comprising an anolyte cell having an anode and a catholyte cell having a cathode.

In some embodiments, the anode is substantially coated with an alloy containing nickel.

In some embodiments, the system comprises a conduit for the recycling of the anolyte.

In some embodiments, the system comprises a said degasification chamber, positioned such that the anolyte of the two-cell electrolytic reactor may be recirculated through the degasification chamber, optionally wherein said degasification chamber contains an ultrasonic probe.

In some embodiments, said degasification chamber has a largely spherical shape and whereby liquid enters and leaves the chamber in a tangential fashion to create a differential centripetal force on bubbles created in the liquid. The gas may be extracted along the liquid recirculation axis.

The centripetal force on said bubbles may be between 0.5-10 g, and pressure within said vessel is between 1.0-6.0 Barg.

In some embodiments, there is a liquid inlet to said degasification chamber containing a sonitrode

In some embodiments, the system may comprise a crystallization chamber and the recirculated solution may pass through the crystallization chamber which is held at a lower temperature than the anolyte chamber.

In one aspect the system comprises a degasification chamber and then through a crystallization chamber arranged such that the recirculated solution passes first through the degasification chamber and then through a crystallization chamber.

In some embodiments, the temperature of degasification in the degasification chamber is maintained such that it is higher than the temperature of crystallization, wherein the evaporation of ammonia during degasification substantially contributes to the heat removal requirement to achieve crystallization of solid ammonium nitrate

In some embodiments, the system comprises two independent recirculation paths, a 1st recirculation path which passes through a degasification chamber, and a 2nd path which passes through a crystallization chamber, optionally wherein both paths return separately to the anolyte chamber. In some embodiments, the 1st path, comprising degasified liquid, depleted of ammonia, returns to a location proximal to the anode, such as within 5 cm of the anode, thus creating a concentration gradient at the anode relative to the bulk solution in the anolyte chamber which promotes the production of ammonia while depressing the production of ammonium and nitrate ions.

In some embodiments, the two recycled streams disclosed above are recombined and dispersed into the anolyte chamber at a location in the reactor proximal to the anode, such as within 5 cm of the anode, thus promoting the production of ammonia, ammonium ion, and nitrate ion.

In some embodiments, in the second reaction chamber gases from the anolyte chamber and the catholyte chamber are kept separated. Gas from the anolyte chamber may be recycled, and gas from the catholyte chamber may be removed.

In some embodiments, the system may comprise a condenser and the recycled anolyte gas may pass through a condenser which is held at a temperature lower than the anolyte chamber.

In some embodiments of the system, recycled anolyte gas is combined with makeup reactant gases at a point before the recycle stream enters the microplasma reactor.

In some embodiments, the anolyte chamber and said catholyte chamber of the second reaction chamber (electrolysis) are separated by a proton membrane which allows the conduction of protons (H+) from the catholyte to the anolyte and conduction of hydroxyl ions (OH−) from the anolyte to the catholyte but disallows the flow of nitrate (NO3−), ammonia (NH3), and ammonium (NH4+) between the catholyte and anolyte chambers.

### Various Embodiments

Zero Carbon in Feedstocks

In some aspects, an advantage of this system over conventional processes is that it uses no carbon compounds as feedstocks. The primary chemical inputs to the process are water and air, and in some aspects of the disclosure, potassium hydroxide—all which are chemicals that contain zero carbon. As a result, carbon dioxide gas is not a by-product of this process.

Avoids High Processing Temperatures and Pressures

Green processes in the prior art include the use of hydrogen gas that is made from renewable energy electrolysis of water. With these alternatives, the green hydrogen is subsequently converted to ammonia using variations of the conventional Haber-Bosch process which is intrinsically carbon footprint intensive. Even though the Haber-Bosch process by itself does not use carbon containing input molecules, the conditions are very energy intensive, including high temperature, high pressure, and the management and transport of hydrogen gas feedstocks. With this disclosure, all of those disadvantages are eliminated, including the production and storage of hydrogen.

Skips Production of Hydrogen Gas, Directly Produces Ammonia

With this disclosure, hydrogen gas is not a primary product of the electrolysis, as a portion of the hydrogen proton reacts in-situ in liquid, making ammonia and ammonium before hydrogen gas is formed. The hydrogen that is formed at the electrolysis anode is recycled back through the plasma jet until it reacts in the plasma phase or subsequent electrolysis step to form ammonia or another molecule, that eventually reacts to become a product that is soluble in liquid. As such, there is no need for hydrogen gas storage in the process as the hydrogen from the water is converted directly to ammonia and ammonium products.

Complete System

None of the very low carbon prior art concepts offer a complete system description that would be essential for the mass production of ammonia. This disclosure does offer a complete system description. For example, prior art offers synthesis of ammonia by plasma reaction, but does not offer a method for dealing with the substantial by-products of the reaction, such as NOR. This disclosure describes a host of ancillary processes, such as degasification, condensation, crystallization, and hardware configurations that make the system complete.

Multiple Products and Production Flexibility

In some embodiments, methods are described for the configuration and set points of the apparatus that produce a range of product mixtures of ammonia, ammonium nitrate, and potassium nitrate. This format creates a foundation for a multitude of project developments that could have very different objectives: ammonia fuel production, w/ nitrogen fertilizer by-product; ammonia fuel production, w/ potassium and nitrogen fertilizer products; hydrogen conversion to liquid ammonia facility (replacement for Haber-Bosch) for hydrogen transportation; production of fertilizer, with ammonia by-product; production of explosives and munitions, with ammonia by-product; and production of pure oxygen (combined with any of the above).

Some aspects of the disclosure include numerous novelties of method and apparatus that create advantages to the system, and which could have advantages in other systems apart from this system.

In some embodiments, allowing more oxygen into the system will produce a higher fraction of ammonium nitrate to ammonia.

In some embodiments, increasing the UV radiation will increase the selectivity of ammonium over ammonia (more protons to form NH₄ vs NH₃).

In some embodiments, increasing ultrasonic energy in the degasifier will increase ammonia gas production over ammonium nitrate production.

In some embodiments, reducing crystallization temperature will increase ammonium nitrate production over ammonia production.

In some embodiments, decreasing temperature of recycled gas condensate will modulate the fraction of NH₃/NO₃ produced in the plasma phase.

In some embodiments, the closed gas recycle loop allows the arbitrary introduction of inert diluent gasses, such as argon, that can modulate plasma discharge efficiency, and modulate plasma to anolyte residence time.

In some embodiments, the length of the dielectric sleeve on the microplasma nozzle can be increased/decreased to achieve the desired speciation that is introduced into the anolyte solution.

In some embodiments, the material characteristics of the dielectric sleeve can be modulated (for example ratio of SiO₂/Si₃N₄) to modulate NH₃/NO₃ selectivity.

### BIBLIOGRAPHY

Aihara, K., Akiyama, M., Deguchi, T., Tanaka, M., Hagiwara, R. & Iwamoto, M. 2016. Remarkable catalysis of a wool-like copper electrode for NH3 synthesis from N2 and H2 in non-thermal atmospheric plasma. Chemical Communications, 52(93):13560-13563.
Akay, G. & Zhang, K. 2017. Process Intensification in Ammonia Synthesis Using Novel Coassembled Supported Microporous Catalysts Promoted by Nonthermal Plasma. Industrial & Engineering Chemistry Research, 56(2):457-468.
Bai, M., Zhang, Z., Bai, M., Bai, X. & Gao, H. 2008. Synthesis of Ammonia Using CH4/N₂ Plasmas Based on Micro-Gap Discharge under Environmentally Friendly Condition. Plasma Chemistry and Plasma Processing, 28(4):405-414.
Brewer, A. K. & Westhaver, J. W. 1929. The Synthesis of Ammonia in the Glow Discharge. The Journal of Physical Chemistry, 33(6):883-895.
Chen, S., Perathoner, S., Ampelli, C., Mebrahtu, C., Su, D. & Centi, G. 2017. Electrocatalytic Synthesis of Ammonia at Room Temperature and Atmospheric Pressure from Water and Nitrogen on a Carbon-Nanotube-Based Electrocatalyst. Angew Chem Int Ed Engl, 56(10):2699-2703.
Chen, X., Li, N., Kong, Z., Ong, W.-J. & Zhao, X. 2018. Photocatalytic fixation of nitrogen to ammonia: state-of-the-art advancements and future prospects. Materials Horizons, 5(1):9-27.
Duan, G., Chen, Y., Tang, Y., Gasem, K. A. M., Wan, P., Ding, D. & Fan, M. 2020. Advances in electrocatalytic ammonia synthesis under mild conditions. Progress in Energy and Combustion Science, 81:100860.
Faryadi, M., Rahimi, M., Moradi, N. & Safari, S. 2015. Ammonia removal using 1.7 MHz high frequency ultrasound in batch and novel dam-weir falling systems. Desalination and Water Treatment, 54(12):3412-3421.
Gómez-Ramirez, A., Cotrino, J., Lambert, R. M. & Gonzalez-Elipe, A. R. 2015. Efficient synthesis of ammonia from N2 and H2 alone in a ferroelectric packed-bed DBD reactor. Plasma Sources Science and Technology, 24(6).
Gómez-Ramirez, A., Montoro-Damas, A. M., Cotrino, J., Lambert, R. M. & Gonzalez-Elipe, A. R. 2017. About the enhancement of chemical yield during the atmospheric plasma synthesis of ammonia in a ferroelectric packed bed reactor. Plasma Processes and Polymers, 14(6): 1600081.
Gorbanev, Y., Vervloessem, E., Nikiforov, A. & Bogaerts, A. 2020. Nitrogen Fixation with Water Vapor by Nonequilibrium Plasma: toward Sustainable Ammonia Production. ACS Sustainable Chemistry & Engineering, 8(7):2996-3004.
Guo, C., Ran, J., Vasileff, A. & Qiao, S.-Z. 2018. Rational design of electrocatalysts and photo(electro)catalysts for nitrogen reduction to ammonia (NH3) under ambient conditions. Energy & Environmental Science, 11(1):45-56.
Haruyama, T., Namise, T., Shimoshimizu, N., Uemura, S., Takatsuji, Y., Hino, M., Yamasaki, R., Kamachi, T. & Kohno, M. 2016. Non-catalyzed one-step synthesis of ammonia from atmospheric air and water. Green Chemistry, 18(16):4536-4541.
Hawtof, R., Ghosh, S., Guarr, E., Xu, C., Sankaran, R. M. & Renner, J. N. 2019. Catalyst-free, highly selective synthesis of ammonia from nitrogen and water by a plasma electrolytic system. Science advances, 5(1):eaat5778.
Hong, J., Aramesh, M., Shimoni, O., Seo, D. H., Yick, S., Greig, A., Charles, C., Prawer, S. & Murphy, A. B. 2016. Plasma Catalytic Synthesis of Ammonia Using Functionalized-Carbon Coatings in an Atmospheric-Pressure Non-equilibrium Discharge. Plasma Chemistry and Plasma Processing, 36(4):917-940.
Hong, J., Prawer, S. & Murphy, A. B. 2014. Production of Ammonia by Heterogeneous Catalysis in a Packed-Bed Dielectric-Barrier Discharge: Influence of Argon Addition and Voltage. IEEE Transactions on Plasma Science, 42(10):2338-2339.
Honkala, K., Hellman, A., Remediakis, I. N., Logadottir, A., Carlsson, A., Dahl, S., Christensen, C. H. & Nørskov, J. K. 2005. Ammonia Synthesis from First-Principles Calculations. Science, 307(5709):555.
Howarth, R. W. 2008. Coastal nitrogen pollution: A review of sources and trends globally and regionally. Harmful Algae, 8(1):14-20.
Iwamoto, M., Akiyama, M., Aihara, K. & Deguchi, T. 2017. Ammonia Synthesis on Wool-Like Au, Pt, Pd, Ag, or Cu Electrode Catalysts in Nonthermal Atmospheric-Pressure Plasma of N2 and H2. ACS Catalysis, 7(10):6924-6929.
Kim, H.-H., Teramoto, Y., Ogata, A., Takagi, H. & Nanba, T. 2017. Atmospheric-pressure nonthermal plasma synthesis of ammonia over ruthenium catalysts. 14(6):1600157.
Kim, S.-C., Park, Y.-K. & Jung, S.-C. 2021. Recent applications of the liquid phase plasma process. Korean Journal of Chemical Engineering, 38(5):885-898.
Kissel, D. E. 2014. The Historical Development and Significance of the Haber Bosch Process. Better Crops With Plant Food, 98(2):31.
Kubota, Y., Koga, K., Ohno, M. & Hara, T. 2010. Synthesis of Ammonia through Direct Chemical Reactions between an Atmospheric Nitrogen Plasma Jet and a Liquid. Plasma and Fusion Research, 5:042-042.
Kyriakou, V., Garagounis, I., Vourros, A., Vasileiou, E. & Stoukides, M. 2020. An Electrochemical Haber-Bosch Process. Joule, 4(1):142-158.
Lindner, P. J. & Besser, R. S. 2012. Hydrogen production by methanol reforming in a non-thermal atmospheric pressure microplasma reactor. International Journal of Hydrogen Energy, 37(18):13338-13349.
MacFarlane, D. R., Cherepanov, P. V., Choi, J., Suryanto, B. H. R., Hodgetts, R. Y., Bakker, J. M., Ferrero Vallana, F. M. & Simonov, A. N. 2020. A Roadmap to the Ammonia Economy. Joule, 4(6):1186-1205.
Matsuo, K., Takatsuji, Y., Kohno, M., Kamachi, T., Nakada, H. & Haruyama, T. 2015. Dispersed-phase Interfaces between Mist Water Particles and Oxygen Plasma Efficiently Produce Singlet Oxygen and Hydroxyl Radical. Electrochemistry, 83(9):721-724.
Medford, A. J. & Hatzell, M. C. 2017. Photon-Driven Nitrogen Fixation: Current Progress, Thermodynamic Considerations, and Future Outlook. AC S Catalysis, 7(4):2624-2643.
Mindong, B., Zhitao, Z., Xiyao, B., Mindi, B. & Wang, N. 2003. Plasma synthesis of ammonia with a microgap dielectric barrier discharge at ambient pressure. IEEE Transactions on Plasma Science, 31(6):1285-1291.
Mingdong, B., Xiyao, B., Zhitao, Z. & Mindi, B. 2000. Synthesis of Ammonia in a Strong Electric Field Discharge at Ambient Pressure. Plasma Chemistry and Plasma Processing, 20(4):511-520.
Mizushima, T., Matsumoto, K., Sugoh, Ohkita, H. & Kakuta, N. 2004. Tubular membrane-like catalyst for reactor with dielectric-barrier-discharge plasma and its performance in ammonia synthesis. Applied Catalysis A: General, 265(1):53-59.
Nakajima, J. & Sekiguchi, H. 2008. Synthesis of ammonia using microwave discharge at atmospheric pressure. Thin Solid Films, 516(13):4446-4451.
Ober, J. A. 2016. Mineral commodity summaries 2016. Reston, Va.: Survey, U.S.G.
Patil, B. S., Hessel, V., Lang, J. & Wang, Q. 2016. CHAPTER 10 Plasma-Assisted Nitrogen Fixation Reactions. Alternative Energy Sources for Green Chemistry. The Royal Society of Chemistry. p. 296-338).
Peng, P., Chen, P., Addy, M., Cheng, Y., Zhang, Y., Anderson, E., Zhou, N., Schiappacasse, C., Hatzenbeller, R., Fan, L., Liu, S., Chen, D., Liu, J., Liu, Y. & Ruan, R. 2018a. In situ plasma-assisted atmospheric nitrogen fixation using water and spray-type jet plasma. Chemical Communications, 54(23):2886-2889.
Peng, P., Chen, P., Schiappacasse, C., Zhou, N., Anderson, E., Chen, D., Liu, J., Cheng, Y., Hatzenbeller, R., Addy, M., Zhang, Y., Liu, Y. & Ruan, R. 2018b. A review on the non-thermal plasma-assisted ammonia synthesis technologies. Journal of Cleaner Production, 177:597-609.
Peng, P., Cheng, Y., Hatzenbeller, R., Addy, M., Zhou, N., Schiappacasse, C., Chen, D., Zhang, Y., Anderson, E., Liu, Y., Chen, P. & Ruan, R. 2017. Ru-based multifunctional mesoporous catalyst for low-pressure and non-thermal plasma synthesis of ammonia. International Journal of Hydrogen Energy, 42(30):19056-19066.
Peng, P., Li, Y., Cheng, Y., Deng, S., Chen, P. & Ruan, R. 2016. Atmospheric Pressure Ammonia Synthesis Using Non-thermal Plasma Assisted Catalysis. Plasma Chemistry and Plasma Processing, 36(5):1201-1210.
Razon, L. F. 2014. Life cycle analysis of an alternative to the haber-bosch process: Non-renewable energy usage and global warming potential of liquid ammonia from cyanobacteria. Environmental Progress & Sustainable Energy, 33 (2): 618-624.
Rossmeisl, J., Qu, Z. W., Zhu, H., Kroes, G. J. & Nørskov, J. K. 2007. Electrolysis of water on oxide surfaces. Journal of Electroanalytical Chemistry, 607(1):83-89.
Rouwenhorst, K. H. R., Kim, H.-H. & Lefferts, L. 2019a. Vibrationally Excited Activation of N2 in Plasma-Enhanced Catalytic Ammonia Synthesis: A Kinetic Analysis. ACS Sustainable Chemistry & Engineering, 7(20): 17515-17522.
Rouwenhorst, K. H. R. & Lefferts, L. 2020. Feasibility Study of Plasma-Catalytic Ammonia Synthesis for Energy Storage Applications. Catalysts, 10(9).
Rouwenhorst, K. H. R., Van der Ham, A. G. J., Mul, G. & Kersten, S. R. A. 2019b. Islanded ammonia power systems: Technology review & conceptual process design. Renewable and Sustainable Energy Reviews, 114:109339.
Saeman, W. C., McCamy, I. W. & Houston, E. C. 1952. Production of Ammonium Nitrate by Continuous Vacuum Crystallization. Industrial & Engineering Chemistry, 44(8):1912-1915.
Sakakura, T., Uemura, S., Hino, M., Kiyomatsu, S., Takatsuji, Y., Yamasaki, R., Morimoto, M. & Haruyama, T. 2018. Excitation of H2O at the plasma/water interface by UV irradiation for the elevation of ammonia production. Green Chemistry, 20(3):627-633.
Scheel, H. J. 2003. The Development of Crystal Growth Technology. Cryst. Growth Technol., John Wiley:1-14.
Schnitkey, G. 2017. Fertilizer Costs in 2017 and 2018. J farmdoc daily, 7.
Shah, J. R., Gorky, F., Lucero, J., Carreon, M. A. & Carreon, M. L. 2020. Ammonia Synthesis via Atmospheric Plasma Catalysis: Zeolite 5A, a Case of Study. Industrial & Engineering Chemistry Research, 59(11):5167-5176.
Shepherd, M. 1941. Analytical separation and purification of gases by fractional distillation and rectification at low temperatures. Journal Research, Nat. Bur. Stand, 26:227.
Singh, A. R., Rohr, B. A., Schwalbe, J. A., Cargnello, M., Chan, K., Jaramillo, T. F., Chorkendorff, I. & Nørskov, J. K. 2017. Electrochemical Ammonia Synthesis—The Selectivity Challenge. ACS Catalysis, 7(1):706-709.
Smith R J, B., Loganathan, M. & Shantha, M. S. 2010. A Review of the Water Gas Shift Reaction Kinetics. International Journal of Chemical Reactor Engineering, 8(1).
Soloveichik, G. 2019. Electrochemical synthesis of ammonia as a potential alternative to the Haber-Bosch process. Nature Catalysis, 2(5):377-380.
Sugiyama, K., Akazawa, K., Oshima, M., Miura, H., Matsuda, T. & Nomura, O. 1986. Ammonia synthesis by means of plasma over MgO catalyst. Plasma Chemistry and Plasma Processing, 6(2):179-193.
Sun, J., Alam, D., Daiyan, R., Masood, H., Zhang, T., Zhou, R., Cullen, P. J., Lovell, E. C., Jalili, A. & Amal, R. 2021. A hybrid plasma electrocatalytic process for sustainable ammonia production. Energy & Environmental Science, 14(2):865-872.
Tanaka, S., Uyama, H. & Matsumoto, O. 1994. Synergistic effects of catalysts and plasmas on the synthesis of ammonia and hydrazine. Plasma Chemistry and Plasma Processing, 14(4):491-504.
Vu, M.-H., Sakar, M., Hassanzadeh-Tabrizi, S. A. & Do, T.-O. 2019. Photo(electro)catalytic Nitrogen Fixation: Problems and Possibilities. Advanced Materials Interfaces, 6(12):1900091.
Wang, L., Xia, M., Wang, H., Huang, K., Qian, C., Maravelias, C. T. & Ozin, G. A. 2018. Greening Ammonia toward the Solar Ammonia Refinery. Joule, 2(6):1055-1074.
Wang, Q., Guo, J. & Chen, P. 2019a. Recent progress towards mild-condition ammonia synthesis. Journal of Energy Chemistry, 36:25-36.
Wang, Y., Craven, M., Yu, X., Ding, J., Bryant, P., Huang, J. & Tu, X. 2019b. Plasma-Enhanced Catalytic Synthesis of Ammonia over a Ni/Al₂O₃Catalyst at Near-Room Temperature: Insights into the Importance of the Catalyst Surface on the Reaction Mechanism. ACS Catalysis, 9(12): 10780-10793.
Wu, C. Q., Zhang, Y. & Chen, X. 2019. Ammonia removal mechanism by the combination of air stripping and ultrasound as the function of pH. IOP Conference Series: Earth and Environmental Science, 344:012051.
Xie, D., Sun, Y., Zhu, T., Fan, X., Hong, X. & Yang, W. 2016. Ammonia synthesis and by-product formation from H2O, H2 and N2 by dielectric barrier discharge combined with an Ru/Al₂O₃ catalyst. RSC Advances, 6(107):105338-105346.
Zapp, K.-H., Wostbrock, K.-H., Schafer, M., Sato, K., Seiter, H., Zwick, W., Creutziger, R. & Leiter, H. 2012. Ammonium Compounds. Ullmann's Encyclopedia of Industrial Chemistry.
Zhou, D., Zhou, R., Zhou, R., Liu, B., Zhang, T., Xian, Y., Cullen, P. J., Lu, X. & Ostrikov, K. 2021. Sustainable ammonia production by non-thermal plasmas: Status, mechanisms, and opportunities. Chemical Engineering Journal, 421.

All patent and publication references mentioned in this specification are herein incorporated by reference to the same extent as if each independent patent and publication reference was specifically and individually indicated to be incorporated by reference.

Where applicable all individual features illustrated in the exemplary embodiments can be combined and/or replaced with each other without leaving the scope of the disclosure. From the foregoing description, it will be apparent that variations and modifications may be made to the embodiments of the present disclosure to adopt it to various usages and conditions. Such embodiments are also within the scope of the following claims.

What is claimed is:

1. A method for synthesis of ammonia from nitrogen and hydrogen, the method comprising use of plasma, such as a microjet plasma, in a first reaction chamber to generate a vibrationally excited nitrogen atom or nitrogen containing molecule, optionally wherein the vibrationally excited nitrogen atom or molecule is reacted with hydrogen in an aqueous medium, optionally wherein the aqueous medium is then recycled to remove soluble products.

2. The method according to claim 1 wherein said plasma is a microjet plasma generated by RF energy conducted through a gas between two electrodes designated as an RF electrode and a GND electrode.

3. The method according to claim 2 wherein a spacing between the two electrodes (gap comprising gas) is between 5 mm and 1 mm, and a gas pressure is between 0.8 Barg and 5 Barg.

4. The method according to claim 3 where both electrodes comprise an alloy of at least 90% tungsten by weight.

5. The method according to claim 1 wherein gas flows through an annulus where an outer surface of the annulus is a GND electrode, and an inner surface of the annulus is an RF electrode, resulting in a cross-sectional gas flow area determined by a radii of both electrodes (R₁=GND radius; R2=RF radius), optionally wherein a length of RF electrode is substantially larger than a thickness of the GND electrode (L₁=GND electrode thickness), resulting in a discharge volume that is proportional to (R₁−R₂)*L₁, where R₁−R₂ is an effective electrode spacing.

6. The method according to claim 5 wherein a gas flow rate achieves a velocity between 0.1-0.90 Mach within a volume of the effective electrode spacing.

7. The method according to claim 1 wherein a gas from the first reaction chamber flows directly into a second reaction chamber wherein said second reaction chamber is a two celled electrolytic reactor comprising an anolyte cell having an anode and a catholyte cell having a cathode.

8. The method according to claim 7 where an excited gas from a first microjet plasma reactor is injected into the anolyte cell in close proximity to the anode.

9. The method according to claim 8 wherein the anode is substantially coated with an alloy comprising nickel.

10. The method according to claim 7 wherein a gas flow rate is sufficient for the gas to reach the anode within 1 second.

11. The method according to claim 1 wherein the generation of a vibrationally exited nitrogen atom or nitrogen containing molecule by plasma is followed by an electrolytic reaction in a two-cell electrolytic reactor comprising an anolyte cell having an anode and a catholyte cell having a cathode, and an anolyte solution is recirculated.

12. The method according to claim 11 wherein recirculated solution passes through a degasification chamber to produce an evaporated gas, optionally wherein said degasification chamber comprises an ultrasonic probe.

13. The method according to claim 12 wherein said degasification chamber has a largely spherical shape and wherein liquid enters and leaves the chamber in a tangential fashion to create a differential centripetal force on bubbles created in the liquid; and further, wherein gas is extracted along a liquid recirculation axis.

14. The method according to claim 12 wherein said degasification chamber has a largely cylindrical shape and wherein liquid enters and leaves the chamber in a tangential fashion to create a differential centripetal force on bubbles created in the liquid; and further, wherein gas is extracted along a liquid recirculation axis.

15. The method according to claim 13 wherein said differential centripetal force on said bubbles is between 0.5-10 g, and pressure within said chamber is between 1.0-6.0 Barg.

16. The method according to claim 12 wherein a liquid inlet to said degasification chamber comprises a sonitrode and a residence time of the liquid between the sonitrode and the degasification chamber is less than 1 second.

17. The method according to claim 12 wherein the evaporated gas comprises predominantly ammonia, nitric oxide and water vapor, or the evaporated gas comprises predominantly ammonia and water vapor, regardless of a degasification method (degasification driven by pressure, heat, ultrasonic, or combination thereof).

18. The method according to claim 11 wherein recirculated solution passes through a crystallization chamber that is held at a lower temperature than the anolyte cell.

19. The method according to claim 11 wherein concentrations of ammonium ion, nitrate ion, and temperature are maintained to result in a precipitation of solid ammonium nitrate, optionally wherein said solid ammonium nitrate is separated from recycled liquor.

20. The method according to claim 11 wherein recirculated solution passes through a crystallization chamber that is held at a lower temperature than the anolyte cell.

21. The method according to claim 11 wherein the recirculated anolyte solution passes first through a degasification chamber and then through a crystallization chamber (series product removal).

22. The method according to claim 21 wherein a product of degasification is substantially ammonia gas that is saturated with water vapor, and a product of crystallization is substantially ammonium nitrate.

23. The method according to claim 22 wherein a temperature of degasification is higher than the temperature of crystallization, wherein an evaporation of ammonia during degasification substantially contributes to a heat removal requirement to achieve crystallization of solid ammonium nitrate.

24. The method according to claim 11 wherein two independent recirculation paths are provided (parallel product removal), a first recirculation path which passes through a degasification chamber, and a second path which passes through a crystallization chamber, optionally wherein both paths return separately to the anolyte cell.

25. The method according to claim 24 whereupon the first path, comprising degasified liquid, depleted of ammonia, returns to a location proximal to the anode, such as within 5 cm of the anode, thus creating a concentration gradient at the anode relative to a bulk solution in the anolyte cell which promotes production of ammonia while depressing production of ammonium and nitrate ions.

26. The method according to claim 25 wherein a ratio of flowrates of the first recirculation path to second liquid recirculation path is adjusted up to increase a molar outflow of elemental nitrogen to elemental oxygen (i.e., increase an output ratio of ammonia to ammonium nitrate).

27. The method according to claim 24 where the two independent recirculation paths are recombined and dispersed into the anolyte cell at a location in the reactor proximal to the anode, such as within 2 cm of the anode, thus promoting the production of ammonia, ammonium ion, and nitrate ion.

28. The method according to claim 1 wherein the generation of a vibrationally exited nitrogen atom or nitrogen containing molecule by plasma in a plasma reactor is followed by an electrolytic reaction in a two cell electrolytic reactor comprising an anolyte cell having an anode and a catholyte cell having a cathode and catholyte solution, wherein gases from the anolyte cell and the catholyte cell are kept separated, wherein gas from the anolyte cell is recycled, and gas from the catholyte cell is removed.

29. The method according to claim 28 wherein the recycled anolyte gas passes through a condenser at a temperature lower than the anolyte cell; whereupon condensate comprises primarily liquid ammonia and water, optionally wherein said condensate liquid is removed as a product, optionally wherein said condenser is comprised of a fractional distillation column so that ammonia can be removed separately from other condensed gases.

30. The method according to claim 28 wherein the recycled anolyte gas is combined with makeup reactant gases before the recycled anolyte gas enters a microplasma reactor.

31. The method according to claim 30 wherein the makeup reactant gases comprises a mixture comprising one or more or all of components of dry air, nitrogen, water vapor, and a noble gas.

32. The method according to claim 31 wherein a molar flow rate of elemental nitrogen in the makeup reactant gases is substantially equivalent to a sum of molar outflow of elemental nitrogen in respective product streams.

33. The method according to claim 31 wherein the noble gas is helium and is added in amounts <10% molar of total recycled gas to maintain a stable microplasma discharge.

34. The method according to claim 28 wherein said anolyte cell and said catholyte cell are separated by a proton membrane which allows a conduction of protons (H+) from catholyte to anolyte and conduction of hydroxyl ions (OH−) from the anolyte to the catholyte but disallows flow of nitrate (NO3−), ammonia (NH3), and ammonium (NH4+) between the catholyte cell and anolyte cell.

35. The method according to claim 28 wherein where a flow of pure water makeup is added to the catholyte cell or as water vapor to the recycled gas.

36. The method according to claim 35 wherein a molar flow rate of elemental oxygen in the pure makeup water is substantially equivalent to or greater than the molar flow rate of elemental oxygen in oxygen gas which is generated at the cathode and subsequently exhausted.

37. The method according to claim 28 wherein a metallic hydroxide is added to the catholyte solution to maintain good conductivity of the solution and promote evacuation of protons through a proton membrane, optionally wherein where the metallic hydroxide is potassium hydroxide.

38. The method according to claim 28 wherein aqueous potassium hydroxide is added independently as a component to both the anolyte cell and catholyte cell.

39. The method according to claim 28 wherein a liquid makeup stream comprising an aqueous solution of potassium hydroxide is added to an electrolyte chamber.

40. The method according to claim 37 wherein a concentration of potassium ion and nitrate ion are such that, at a temperature of a crystallizer, predominantly potassium nitrate is a solid precipitant.

41. The method according to claim 39 wherein an elemental potassium flow rate in the said liquid makeup stream is equal to an elemental potassium flow rate in a solid precipitant and, an elemental oxygen flow rate in said liquid makeup stream is equivalent to a combination of elemental oxygen flow rates of: said gas from the catholyte cell, plus said solid precipitant, minus said makeup gas streams.

42. A system for synthesis of ammonia from nitrogen and hydrogen, the system comprising: a first reaction chamber in which plasma is used to generate a vibrationally exited nitrogen atom or nitrogen containing molecule; and a second reaction chamber which is a two celled electrolytic reactor comprising an anolyte cell having an anode and a catholyte cell having a cathode, wherein excited gas from the first reaction chamber is injected into the anolyte cell.

43. The system according to claim 42 wherein said plasma is a microjet plasma generated by RF energy conducted through a gas between two electrodes designated as an RF electrode and a GND electrode.

44. The system according to claim 43 wherein a spacing between the two electrodes (gap comprising gas) is between 5 mm and 1 mm, and a gas pressure is between 0.8 Barg and 5 Barg.

45. The system according to claim 44 where both electrodes comprise an alloy of at least 90% tungsten by weight.

46. The system according to claim 45 wherein gas is configured to flow through an annulus where an outer surface of the annulus is a GND electrode, and an inner surface of the annulus is an RF electrode, resulting in a cross-sectional gas flow area determined by a radii of both electrodes (R₁=GND radius; R₂=RF radius), optionally wherein a length of RF electrode is substantially larger than a thickness of the GND electrode (L₁=GND electrode thickness), resulting in a discharge volume that is proportional to (R₁−R₂)*L₁, where R₁−R₂ is an effective electrode spacing.

47. The system according to claim 42 wherein a gas from the first reaction chamber is configured to flow directly into a second reaction chamber wherein said second reaction chamber is a two celled electrolytic reactor comprising an anolyte cell having an anode and a catholyte cell having a cathode.

48. The system according to claim 47 wherein the anode is substantially coated with an alloy comprising nickel.

49. The system according to claim 42 further comprising a two-cell electrolytic reactor comprising an anolyte cell having an anode and a catholyte cell having a cathode, and an anolyte solution is configured to be recirculated.

50. The system according to claim 49 wherein the recirculated solution is configured to pass through a degasification chamber to produce an evaporated gas, optionally wherein said degasification chamber comprises an ultrasonic probe.

51. The system according to claim 50 wherein said degasification chamber has a largely spherical shape and wherein liquid is configured to enter and leave the chamber in a tangential fashion to create a differential centripetal force on bubbles created in the liquid; and further, wherein gas is configured to be extracted along a liquid recirculation axis.

52. The system according to claim 50 wherein said degasification chamber has a largely cylindrical shape and wherein liquid is configured to enter and leave the chamber in a tangential fashion to create a differential centripetal force on bubbles created in the liquid; and further, wherein gas is configured to be extracted along a liquid recirculation axis.

53. The system according to claim 50 wherein a liquid inlet to said degasification chamber comprises a sonitrode and a residence time of the liquid between the sonitrode and the degasification chamber is less than 1 second.

54. The system according to claim 49 wherein recirculated solution is configured to pass through a crystallization chamber that is held at a lower temperature than the anolyte cell.

55. The system according to claim 49 wherein two independent recirculation paths are provided (parallel product removal), a first recirculation path which passes through a degasification chamber, and a second path which passes through a crystallization chamber, optionally wherein both paths return separately to the anolyte cell.

56. The system according to claim 55 wherein the two independent recirculation paths are recombined and dispersed into the anolyte cell at a location in the reactor proximal to the anode, such as within 2 cm of the anode, thus promoting the production of ammonia, ammonium ion, and nitrate ion.

57. The system according to claim 42 wherein a plasma reactor is followed by a two cell electrolytic reactor comprising an anolyte cell having an anode and a catholyte cell having a cathode and catholyte solution, wherein gases from the anolyte cell and the catholyte cell are configured to be kept separated, wherein gas from the anolyte cell is configured to recycled, and gas from the catholyte cell is configured to be removed.

58. The system according to claim 57 further comprising a condenser adapted to pass the recycled anolyte gas at a temperature lower than the anolyte cell; optionally wherein said condenser is comprised of a fractional distillation column so that ammonia can be removed separately from other condensed gases.

59. The system according to claim 57 further comprising a microplasma reactor configured to receive the recycled anolyte gas combined with makeup reactant gases.

60. The system according to claim 57 wherein said anolyte cell and said catholyte cell are separated by a proton membrane which allows a conduction of protons (H+) from catholyte to anolyte and conduction of hydroxyl ions (OH−) from the anolyte to the catholyte but disallows flow of nitrate (NO3−), ammonia (NH3), and ammonium (NH4+) between the catholyte cell and anolyte cell.
